(19) United States
(12) Patent Application Publication
(10) Pub. No.: US 2017/0114625 A1
(43) Pub. Date: Apr. 27, 2017

(54) SYSTEM AND METHOD FOR MONITORING COMPONENT SERVICE LIFE

(71) Applicants: LORD Corporation, Cary, NC (US); CALFRAC WELL SERVICES LTD., Calgary (CA)

(72) Inventors: Mark A. NORRIS, Cary, NC (US); Christopher P. TOWNSEND, Shelburne, VT (US); Michael ROBINSON, Charlotte, VT (US); Leslie Michael WISE, Calgary (CA); Gregory KESSLER, Brighton, CO (US); Daniel O'NEIL, St. Albans, VT (US)

(21) Appl. No.: 15/316,963

(22) PCT Filed: Jun. 12, 2015
(86) PCT No.: PCT/US2015/035563

§ 371 Date: Dec. 7, 2016

Related U.S. Application Data
(60) Provisional application No. 62/012,119, filed on Jun. 13, 2014.

(51) Int. Cl. E21B 47/00; F04B 51/00; G05B 19/4065; E21B 43/26; G01L 5/00

(52) U.S. Cl. CPC E21B 47/00; E21B 43/26; G01L 5/0061; G05B 19/4065; F04B 51/00; E21B 43/267

(57) ABSTRACT

Systems and methods are disclosed herein that include providing a service life monitoring system that includes a rotatable component and a rotatable measurement interface disposed on the rotatable component, the rotatable measurement interface having at least one torsional strain gauge configured to measure a strain of the rotatable component, a strain monitor controller configured to receive the measured strain of the rotatable component, and a wireless data transmission component configured to wirelessly communicate with the strain monitor controller to receive the measured strain, determine at least one of a power, rotational speed, torque, and service life of the rotatable component in response to receiving the measured strain of the rotatable component as a result of the measured strain of the rotatable component, and control at least one of the power, the rotational speed, and the torque of the rotatable component.

### CROSS-REFERENCE TO RELATED APPLICATION

The instant application claims the benefit of U.S. Provisional Patent Application Ser. No. 62/012,119, filed Jun. 13, 2014, the disclosure of which is incorporated herein by reference in its entirety.

### TECHNICAL FIELD

Embodiments described herein relate to wellbore servicing equipment and methods of servicing a wellbore.

### BACKGROUND

Pumps are sometimes used to deliver wellbore servicing fluid into a wellbore. In some cases, electric motors and/or internal combustion engines drive transmissions while output shafts associated with the transmission drive the associated pumps. While the shafts are exposed to the normally occurring forces associated with driving the rotationally resistive load, the pumps themselves may additionally feed back cyclic and/or intermittent forces to the shafts and/or transmissions. The additional forces combined with the normally occurring forces may reduce a service life of the shafts, transmissions, and/or other driveline components.

### SUMMARY

In accordance with this disclosure, a system and method of servicing a wellbore is disclosed.

In one aspect, a method of servicing a wellbore is provided. The method comprises:
a. providing a rotatable component;
b. disposing a rotatable measurement interface on the rotatable component; rotating the rotatable component; and
c. operating the rotatable measurement interface to measure a service life parameter of the rotatable component.

In another aspect, a method of servicing a wellbore is provided. The method comprises:
a. providing a rotatable component;
b. disposing a rotatable measurement interface on the rotatable component; rotating the rotatable component;
c. operating the rotatable measurement interface to measure a strain of the rotatable component; and
d. predicting a service life of the rotatable component in response to the measured strain of the rotatable component.

In another aspect, a service life monitoring system is provided. The service life monitoring system comprises a rotatable component and a rotatable measurement interface. The rotatable measurement interface is disposed on the rotatable component. The rotatable measurement interface includes a strain gauge configured to measure a strain of the rotatable component and a strain monitor controller configured to receive the strain of the rotatable component.

In yet another aspect, a service life monitoring system is provided. The service life monitoring system comprises a rotatable component and a rotatable measurement interface. The rotatable measurement interface is disposed on the rotatable component. The rotatable measurement interface includes a strain gauge configured to measure a strain of the rotatable component, a strain monitor controller configured to receive the measured strain of the rotatable component, and a wireless data transmission component configured to wirelessly communicate with the strain monitor controller to determine an operating parameter of the rotatable component.

In another aspect, a service life monitoring system is provided. The service life monitoring system comprises a rotatable component and a rotatable measurement interface. The rotatable measurement interface is disposed on the rotatable component. The rotatable measurement interface includes at least one torsional strain gauge configured to measure a strain of the rotatable component, a strain monitor controller configured to receive the measured strain of the rotatable component, and a wireless data transmission component configured to wirelessly communicate with the strain monitor controller to determine a service life of the rotatable component as a result of the measured strain of the rotatable component.

### BRIEF DESCRIPTION OF THE DRAWINGS

FIG. 1 is a simplified schematic view of a wellbore servicing system according to an embodiment.

FIG. 2 is a partial oblique view of a pumping system of the wellbore servicing system of FIG. 1.

FIG. 3 is an oblique view of a service life monitoring system of the pumping system of FIG. 2.

FIG. 4 is an oblique view of an alternative embodiment of a service life monitoring system.

FIG. 5 is a graph of an example output from the service life monitoring system of FIG. 3.

FIG. 6 is a graph that usable in estimating a remaining fatigue life of a component of the pumping system of FIG. 2.

FIG. 7 is a flowchart of a method of operating a service life monitoring system.

FIG. 8 is a table of tensile test results for a variety of materials.

FIG. 9 is a chart of ultimate strength of a material versus fatigue strength fraction.

FIG. 10 is a chart of number of stress cycles versus fatigue strength.

FIG. 11 is a flowchart of another method of operating a service life monitoring system.

FIG. 12 is a strain time history graph related to an example implementation of the method of FIG. 11.

FIG. 13 is a strain spectrum graph related to an example implementation of the method of FIG. 11.

### DETAILED DESCRIPTION

This application discloses systems and methods for monitoring and/or predicting a service life of a wellbore servicing component such as a shaft that joins a transmission to a pump. In some wellbore servicing systems, the operation of a pump may generate cyclic and/or intermittent forces and/or vibrations that feed back to a rotatable component such as the shaft, the transmission, and/or other driveline components, so that the shaft, transmission, and/or other rotating driveline components not only experience the normally anticipated forces of driving resistive rotation loads but also cyclic and/or intermittent variations in rotational loading attributable to the configuration of the one or more plungers of the pumps. The systems and methods disclosed herein monitor the effect of the forces applied to the shaft, the transmission, and/or other driveline components in a manner configured to allow: prediction of a time of failure of a shaft and/or transmission; manual and/or automatic removal of a shaft and/or transmission from service prior to a predicted failure; manual and/or automatic removal of a shaft and/or transmission from service in response to a loading profile identified as an indicator of an onset of failure of a shaft and/or transmission; and/or monitoring and/or collection of data regarding loading of a shaft and/or transmission for later evaluation and compilation. Accordingly, a wellbore servicing system 100 is disclosed below that may be operated according to a variety of methods and embodiments described herein.

For exemplary purposes hydraulic fracturing is used as the wellbore servicing system 100, but the system and method of monitoring shafts/drivelines, pumps, transmissions and associated prime mover (e.g., reciprocating engines, electric motors, hydraulic motors, turbines, etc.) applies to any well servicing system incorporating at least a pump, a shaft/driveline and a prime mover. The pump can be any type of pump suitable for use at a well site to service the well.

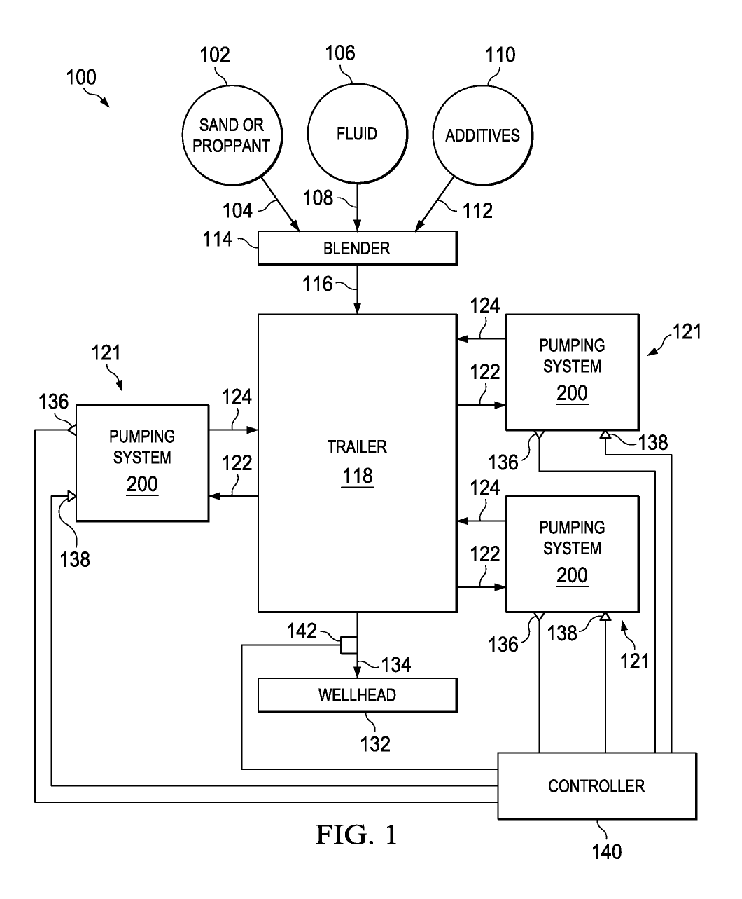

Referring to FIG. 1, a wellbore servicing system 100 is shown. The wellbore servicing system 100 is configurable for fracturing wells in low-permeability reservoirs, among other wellbore servicing jobs. In fracturing operations, wellbore servicing fluids, such as particle laden fluids, are pumped at high pressure downhole into a wellbore. In this embodiment, the wellbore servicing system 100 introduces particle laden fluids into a portion of a subterranean hydrocarbon formation at a sufficient pressure and velocity to cut a casing, create perforation tunnels, and/or form and extend fractures within the subterranean hydrocarbon formation. Proppants, such as grains of sand, are mixed with the wellbore servicing fluid to keep the fractures open so that hydrocarbons may be produced from the subterranean hydrocarbon formation and flow into the wellbore. Hydraulic fracturing creates high-conductivity fluid communication between the wellbore and the subterranean hydrocarbon formation.

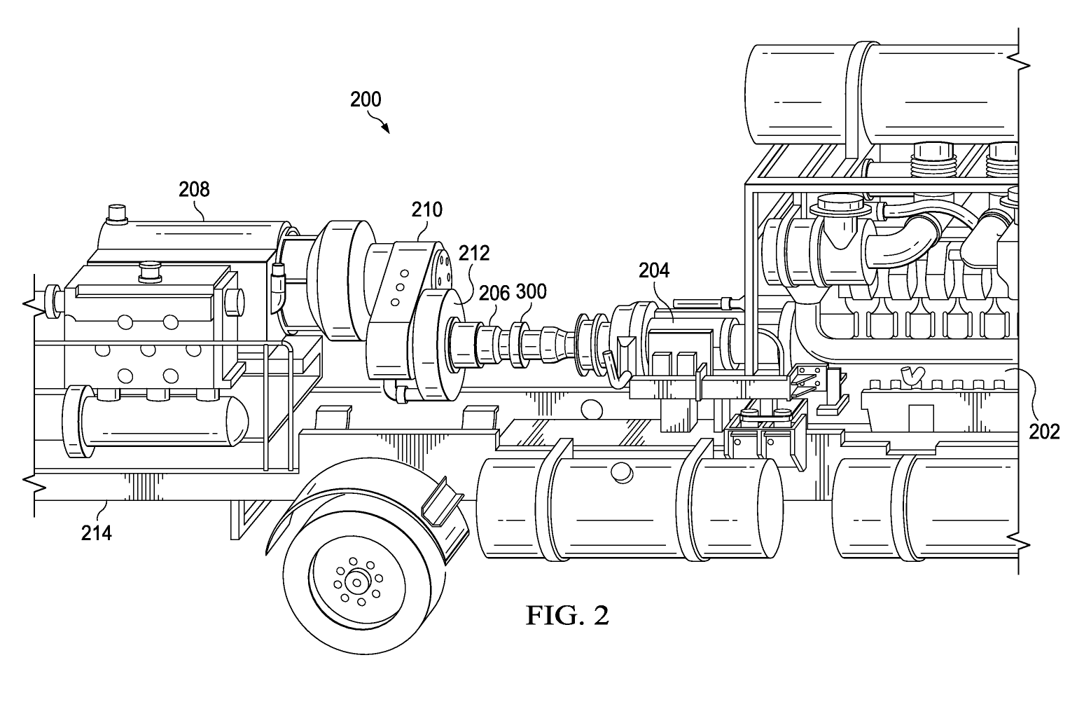

The wellbore servicing system 100 comprises a blender 114 that is coupled to a wellbore services manifold trailer 118 via a flowline 116 and/or a plurality of flowlines 116. As used herein, the term “wellbore services manifold trailer” is meant to collectively comprise a truck and/or trailer comprising one or more manifolds for receiving, organizing, and/or distributing wellbore servicing fluids during wellbore servicing operations. In this embodiment, the wellbore services manifold trailer 118 is coupled via outlet flowlines 122 and inlet flowlines 124 to three pumping systems 200, such as the pumping system shown in FIG. 2 and discussed in more detail herein. Outlet flowlines 122 supply fluid to the pumping systems 200 from the wellbore services manifold trailer 118. Inlet flowlines 124 supply fluid to the wellbore services manifold trailer 118 from the pumping systems 200. Together, the three pumping systems 200 form a pump group 121. In alternative embodiments, however, there may be more or fewer pumping systems 200 used in a wellbore servicing operation. The wellbore services manifold trailer 118 generally has manifold outlets from which wellbore servicing fluids flow to a wellhead 132 via one or more flowlines 134.

The blender 114 mixes solid and fluid components to achieve a well-blended wellbore servicing fluid. As depicted, sand or proppant 102, water or other carrier fluid 106, and additives 110 are fed into the blender 114 via feedlines 104, 108, and 112, respectively. The fluid 106 may be potable water, non-potable water, untreated, or treated water, hydrocarbon based or other fluids. The mixing conditions of the blender 114, including time period, agitation method, pressure, and temperature of the blender 114, is chosen by one of ordinary skill in the art with the aid of this disclosure to produce a homogeneous blend having a desirable composition, density, and viscosity. In alternative embodiments, however, sand or proppant, water, and additives may be premixed and/or stored in a storage tank before entering the wellbore services manifold trailer 118.

The wellbore servicing system 100 further comprises sensors 136 associated with the pumping systems 200 to sense and/or report operational information about the pumping systems 200. The wellbore servicing system 100 further comprises pumping system control inputs 138 associated with the pumping systems 200 to allow selective variation of the operation of the pumping systems 200 and/or components of the pumping systems 200. In this embodiment, operational information about the pumping systems 200 is generally communicated to a main controller 140 by the sensors 136. Further, the pump system control inputs 138 are configured to receive signals, instructions, orders, states, and/or data sufficient to alter, vary, and/or maintain an operation of the pumping systems 200. The main controller 140, sensors 136, and pumping system control inputs 138 are configured so that each pumping system 200 and/or individual components of the pumping systems 200 are independently monitored and are configured so that operations of each pumping system 200 and/or individual components of the pumping systems 200 may be independently altered, varied, and/or maintained. The wellbore servicing system 100 further comprises a combined pump output sensor 142. The combined pump output sensor 142 is shown as being associated with flowline 134 which carries a fluid flow that results from the combined pumping efforts of all three pumping systems 200. The combined pump output sensor 142 is configured to monitor and/or report combined pump effect operational characteristic values (defined and explained infra) to the main controller 140. Alternatively, the combined output can be obtained by summing the output from individual sensors 136.

Referring now to FIG. 2, each pumping system 200 comprises a power source 202 and a plurality of rotatable components such as a transmission 204, a shaft 206, and a pump 208. Transmission 204, shaft 206 and pump 208 are individual and/or collectively referred to herein as rotatable components. The rate of rotation may be changed in the rotatable component in response to the measured service life parameter. Methods of use may include changing a rate of rotation of the rotatable component in response to the measured service life parameter.

Most generally, the power source 202 drives the transmission 204, the transmission 204 drives the shaft 206, and the shaft 206 drives the pump 208. In some cases the pumping system 200 comprises a pump gearbox 210 disposed between the shaft 206 and the pump 208, so that the shaft 206 drives the pump gearbox 210, and the pump gearbox 210 drives the pump 208. In this embodiment, the power source 202 comprises a diesel fuel internal combustion engine, and the pump 208 comprises a positive displacement pump.

In alternative embodiments, the power source 202 comprises an electrically powered motor. In alternative embodiments, the pump 208 may not be a positive displacement pump but rather may comprise any other suitable type of pump. In some embodiments, the positive displacement pumps comprise three plungers and be referred to as a triplex pump. In other embodiments, the positive displacement pumps may be a quadruplex pump and comprise four plungers or a quintuplex pump and comprise five plungers. However, in other embodiments, the positive displacement pump may comprise any other suitable number of plungers. In some embodiments, the pump 208 comprises multiple plungers that operate in phase with each other. For example, a pump 208 comprises six plungers wherein a first set of plungers are in phase with each other, a second set of plungers that are in phase with each other but out of phase with the first set of plungers, and a third set of plungers that are in phase with each other but out of phase with the first set of plungers and the second set of plungers. In some cases, the number, size, and/or relative phase of the plungers of a positive displacement pump may contribute to cyclical and/or intermittent forces that are fed back to one or more of the transmission 204, shaft 206, and/or pump gearbox 210. In some cases, the forces fed back to the rotatable components such as the transmission 204, shaft 206, pump 208, and/or pump gearbox 210 may affect a service life of those components, so that the service life of those components is affected to be different than if the transmission 204, shaft 206, pump 208, and/or pump gearbox 210 were to simply experience a constant and/or non-cyclical variation in rotational resistance. In some embodiments, a rotational fluid damper 212 is provided in the force path of the shaft 206 to reduce variations in rotational resistance applied to the shaft 206 and/or the pump gearbox 210. In this embodiment, the pumping system 200 further comprises a service life monitoring system 300. Further, in some embodiments, the pumping system 200 comprises a hydraulic fracturing truck 214 configured to carry, support, and/or transport other portions and/or components of the pumping system 200.

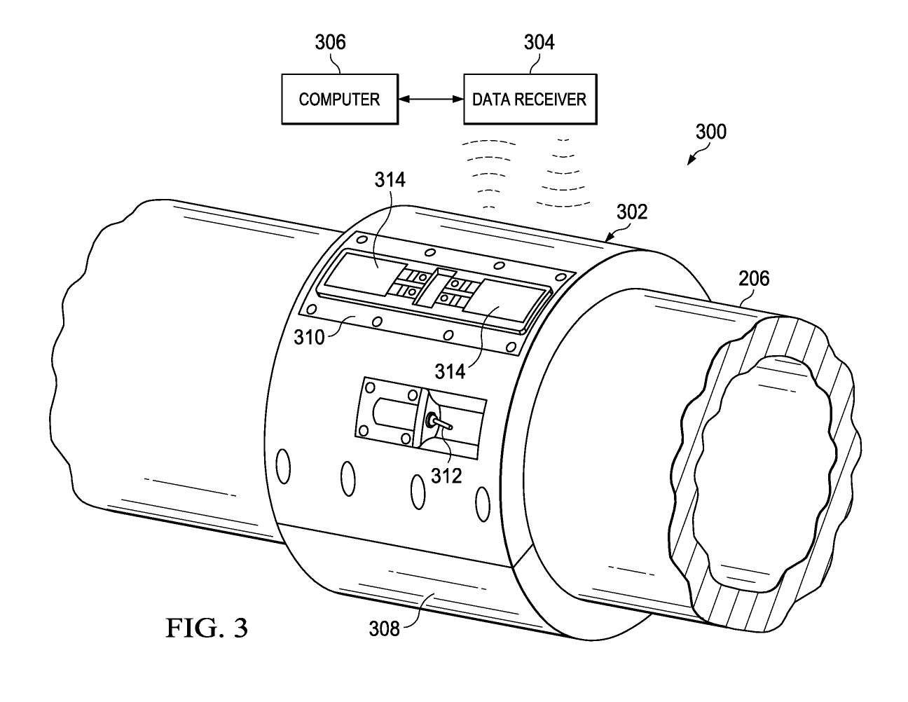

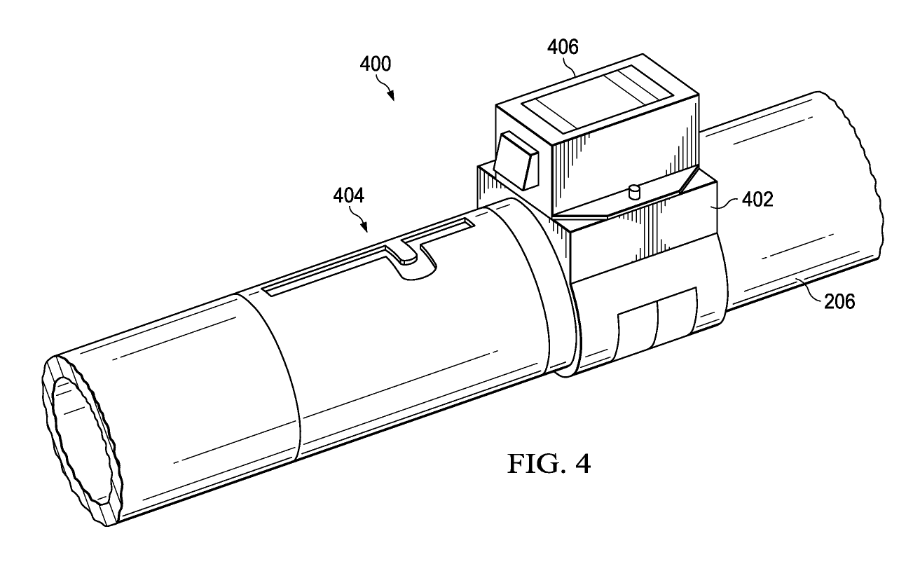

Referring now to FIG. 3, the service life monitoring system 300 generally comprises a rotatable measurement interface 302 such as a LORD MicroStrain Torque Link, a data receiver 304 such as a LORD MicroStrain WSDA-1500 that utilizes platforms such as SensorCloud and MathEngine® for back end analytics, and a service life management computer 306 which in turn would provide truck adjustments to the pumping system 200 control inputs 138. In this embodiment, the rotatable measurement interface 302 comprises a sleeve enclosure 308 configured to enable attachment of the rotatable measurement interface 302 to an exterior of the shaft 206. The sleeve enclosure 308 may be attached to the rotating shaft via mechanical fasteners, adhesive, adhesive-backed tape, and/or any combination thereof. The rotatable measurement interface 302 further comprises at least one measuring component such as a torsional strain gauge (see strain gauges 404 FIG. 4) that, in this embodiment, are connected to the shaft 206 between the sleeve enclosure 308 and the shaft 206 so that they are obscured from view and so that during operation of the system 100, the connection between the strain gauges and the shaft 206 are protected from inadvertent damage, environmental effects, and/or impact.

The rotatable measurement interface 302 further comprises a strain monitor controller 310 such as a LORD MicroStrain SG-Link® system or Strain-Link system, that is located internally to the sleeve enclosure 308 and is configured to apply any necessary power to the strain gauges, receive and interpret signals from the strain gauges, record strain information obtained from the strain gauges, wirelessly transmit information about the operation of the rotatable measurement interface 302, and/or receive instructions regarding controlling the operation of the rotatable measurement interface 302.

The rotatable measurement interface 302 further comprises an electrical power source configured to provide electrical power to at least one component of the rotatable measurement interface 302 such as batteries 314, at least one user interface control switch such as power switch 312 for powering the rotatable measurement interface on and/or off, antennas, and/or any other suitable components for communicating with the rotatable measurement interface 302, controlling the rotatable measurement interface 302, and/or monitoring the rotatable measurement interface 302 regardless of whether the rotatable measurement interface 302 is installed onto the shaft 206, regardless of whether the rotatable measurement interface 302 is rotating, and regardless of whether the rotatable measurement interface 302 is measuring, recording, and/or otherwise monitoring a strain of the shaft 206.

In some embodiments, batteries 314 may be externally accessible while the sleeve enclosure 308 is attached to the shaft 206. In some embodiments, the rotatable measurement interface 302 comprises a noncontact electrical power source that utilizes two inductive coils arranged in close proximity to transfer power from the fixed component (a non-rotating component) to the rotatable component (shaft 206, rotatable measurement interface 302, and/or components of the rotatable measurement interface 302). In such embodiments, the fixed frame coil is attached to the mechanical system electrical bus on the pumping system 200, from which it derives system power. Through inductive effect, this power is transferred across a small air gap to the coil on the rotating shaft 206. This manner of operation provides power to the rotatable measurement interface 302 consistent with truck power, thereby removing the need for external mechanical power switches 312 and batteries 314. Additionally, in some embodiments, the components of the rotatable measurement interface 302 may be distributed angularly and/or radially about the shaft 206 to minimize any unbalancing forces that may be generated by rotation of the rotatable measurement interface 302 along with the shaft 206.

In some embodiments, the sleeve enclosure 308 comprises a rapidly produced component that is sized and/or configured to complement a shaft such as shaft 206. In some cases, the rapid prototyping, machining, injection molding, and/or production of the sleeve enclosure 308 enables customized interior profiles of the sleeve enclosure 308 to a particular shaft 206 that may not have been produced in accordance with strict outer dimension tolerances. In some embodiments, a method of providing a sleeve enclosure 308 comprises accurately measuring the external dimensions of the shaft 206, selecting an installation location on the shaft 206, and generating an interior profile of the sleeve enclosure 308 as a function of the measured outer dimensions of the shaft 206. Further, the rapid prototyping, machining, injection molding, and/or production of the sleeve enclosure 308 comprises selecting locations of components carried by the sleeve enclosure 308 as a function of the measured outer dimensions of the shaft 206. For example, after measuring the outer dimension of the shaft 206, cavities and/or voids within the sleeve enclosure 308 is spatially located radially and/or angularly about an axis of rotation in a manner configured to reduce any rotational and/or inertial imbalances that may result from rotation of the sleeve enclosure 308.

Referring now to FIG. 4, an alternative embodiment of a rotatable measurement interface 400 is shown. The rotatable measurement interface 400 is substantially similar to the rotatable measurement interface 302. However, the rotatable measurement interface 400 differs from the rotatable measurement interface 302 because the sleeve enclosure 402 of the rotatable measurement interface 400 does not house, encompass, and/or protect substantially all of the components of the rotatable measurement interface 400. In particular, while the rotatable measurement interface 400 comprises strain gauges 404, the strain gauges 404 are not located radially between the sleeve enclosure 402 and the shaft 206. Instead, the strain gauges 404 remain relatively exposed to the environment. Similarly, the strain monitor controller 406 of the rotatable measurement interface 400 is not located internal to the sleeve enclosure 402 but rather is bolted and/or otherwise mounted to the sleeve enclosure 402 in such a way that the sleeve enclosure 402 and the strain monitor controller 406 extend radially from the shaft 206 at distances that are significantly different in a manner that may distribute the weight of the rotatable measurement interface 400 unevenly and/or may lead to a rotational imbalance when the rotatable measurement interface is rotated.

In some embodiments, the strain monitor controllers 310, 406 generally comprise the components necessary for operation substantially similar to the operation of one or more of the wireless microstrain node systems made available by LORD Microstrain. For example, the strain monitor controller 310, 406 may comprise an “SG-Link®” or “Strain Gauge—Link” wireless analog sensor node that features a differential input channel with optional bridge completion, a single ended input channel with 0-3 volt excitation, and an internal temperature sensor channel. This wireless analog sensor node is configurable to receive information from the strain gauges 404, wirelessly transmit data based on information from the strain gauges 404, record data to internal memory and/or transmit real-time data to data receiver 304 at user programmable data rates up to 4096 Hz. The microstrain node system cooperates with “Node Commander®” software implemented on a computer such as the service life management computer 306 to allow remote configuration of the wireless analog sensor node, including but not limited to discovery, initialization, radio frequency, sample rate, reading/writing to node EEPROM, calibrating sensors (such as strain gauges 404), managing batteries including sleep, wake, and cycle power, and upgrading firmware. In alternative embodiments, the strain monitor controllers 310, 406 comprise components and related functionality capabilities of other wireless analog sensor nodes substantially similar to the “V-Link®” and/or the Wireless Sensor Data Aggregator (WSDA®) products made available by LORD Microstrain. The WSDA in any form functions as a wireless data transmission component.

In operation, the service life monitoring system 300 may be attached to a shaft 206. Before and/or after attachment of the service life monitoring system 300 to the shaft 206, the rotatable measurement interfaces 300, 402 wirelessly communicates with a data receiver such as data receiver 304 and/or a service life management computer such as service life management computer 306 to at least one of initialize, calibrate, instruct, partially power up and/or down, and/or otherwise enable control and/or communication with the rotatable measurement interfaces 300, 402. After the rotatable measurement interfaces 300, 402 are attached to the shaft 206, a power source such as power source 202 operates to drive a transmission such as transmission 204 and resultantly to drive shaft 206. During rotation of the shaft 206, the rotatable measurement interfaces 300, 402 operate to excite, power, monitor, and/or otherwise make use of the strain gauges of the rotatable measurement interfaces 300, 402.

In some embodiments, the strain gauges may be bridged and/or otherwise electrically connected to the strain monitor controllers 310, 406 in a manner configured to provide electrical feedback and/or signals indicative of a torsional strain of the shaft 206. In alternative embodiments, strain gauges 404 may instead and/or additionally be bridged and/or otherwise electrically connected to the strain monitor controllers 310, 406 in a manner configured to provide electrical feedback and/or signals indicative of a torque of the shaft 206. The electrical feedback and/or signals received by the strain monitor controllers 310, 406 from the strain gauges 404 may then be recorded to a memory of and/or by the strain monitor controllers 310, 406, transmitted wirelessly to the data receiver 304, and/or both. In some cases, the electrical feedback and/or signals received by the strain monitor controllers 310, 406 are conditioned, transformed, and/or otherwise reconfigured to directly indicate a service life parameter and/or rotational parameter such as a strain, microstrain, torque, power, stress, and/or any other parameter derivable from the electrical feedback and/or signals. In some cases, information regarding more than one of the derivable parameters may be received, calculated, and/or transmitted by the strain monitor controller 310, 406. In some cases, raw data regarding the electrical feedback and/or signals from the strain gauges 404 may be received and/or transmitted by the strain monitor controllers 310, 406 to the data receiver 304 for manipulation and/or evaluation by the service life management computer 306.

In some cases, the service life management computer 306 is configurable to use tools such as SensorCloud and MathEngine® to record the received electrical feedback and/or signals of the strain gauges 404. The service life management computer 306 may further correspond, link, and/or associate the electrical feedback and/or signals to torque measurements via a shunt or empirical calibration and/or utilize information derived from the electrical feedback and/or signals of the strain gauges 404 by the strain monitor controllers 310, 406 to deliver shaft power, RPM, operational characteristics, and calculate, monitor, estimate, trend, and/or predict a service life of one or more rotatable components such as the shaft 206, the transmission 204, the pump gearbox 210, the pump 208, and/or any other rotatable component of the pumping system 200 that has a service life dependent in some manner upon one or more of the same parameters that affect a service life of the shaft 206, referred to herein as service life parameters. The service life parameter may be selected from the group consisting of a strain, a stress, a torque, a power and combinations thereof.

In some cases, analysis of a history of exposure of the shaft 206 is used to generate an estimate remaining service life of the shaft 206 and/or any other component of the pumping system 200. In particular, data and/or information related to the history of exposure of the shaft 206 is used to calculate a stress-life and/or a strain-life for the shaft 206 and/or any other component of the pumping system 200. The stress-life and the strain-life may comprise models based on fatigue crack initiation. In alternative embodiments, a fatigue crack growth model in addition to and/or instead of a crack initiation model may be used to obtain a whole fatigue life estimate for the pumping system 200. In alternative embodiments, the rotatable measurement interface may instead or additionally comprise vibration sensors and/or acoustic sensors configured to receive vibratory and/or acoustics signals from the shaft 206. In such cases, the vibratory and/or acoustic signals are used to similarly calculate at least one of a stress-life, strain-life, and/or whole fatigue life estimate for the shaft 206 and/or any other pumping system 200 component associated with the shaft 206.

In some cases, analysis of the power delivered to the shaft 206 from the engine 202 versus the power output of the pump 208 is used to determine a declining performance envelope for the pump and a therefore usable a service life metric. Using this metric, it is possible to trend impending pump system 200, pump 208, gearbox 210, shaft 206 and transmission 204 failures associated with service life limits Using these metrics, as recorded in SensorCloud, and with MathEngine® analytics, it is possible to establish safe thresholds for service life that, when exceeded, will deliver an alert, or warning to operators via email, SMS, and/or via a user interface to notify an operator of the condition. This metric alternately may be used to adjust control inputs to the pump system to prevent fatigue or service life limit failures during operation by “derating” or reducing truck performance temporarily until operators can safely stop the truck for maintenance and replacement.

In some embodiments, the service life monitoring system 300 conditions an action on whether the strains and/or stresses experienced by the shaft have exceeded or sufficiently approached an endurance strain limit of the material of the shaft and/or endurance stress limit of the material of the shaft. For example, if the strains and/or stresses of the shaft 206 are determined to exceed a predetermined threshold, control inputs 138 are adjusted by direction from the service life management computer 306 based on information received from the rotatable measurement interface 302 to optimize the pumping system 200 and/or an action may be taken to at least issue an alert regarding the exposure of the shaft 206 to less than ideal conditions for the shaft 206 and/or reduce utilization of the pumping system 200 comprising the shaft 206 to which the recorded exposure history applies.

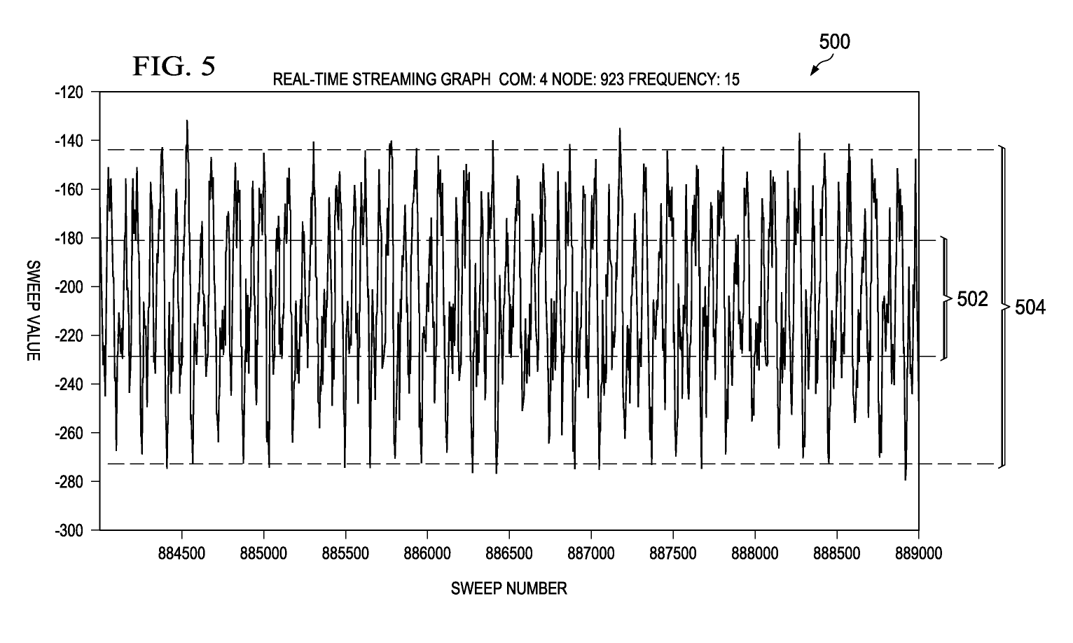

Referring now to FIG. 5, an example output 500 of service life monitoring system 300 is provided. The example output 500 comprises a recorded history of microstrain of a shaft such as shaft 206 over a period of time. The example output 500 shows that the cyclic strains generally associated with the envelope 502 are relatively low in magnitude and consistent in frequency. The example output 500 also shows that the cyclic strains generally associated with the envelope 504 are relatively much greater than the strains of the envelope 502 and do not occur at as high of a frequency as the majority of microstrain perturbations of the envelope 504.

In some embodiments, the content of the example output 500 provides information about dynamic strains in drive shafts to predict and/or estimate cyclic fatigue in drive lines/shafts. In the example output 500, a dynamic strain value has a nominal microstrain of 200+/−50 microstrain at frequency of about 15 Hz which is about the same frequency as the torsional resonance of the drive shaft 206 and resulting in the first torsional harmonic of about 15 Hz wherein the torsional resonance of the drive shaft 206 is about 15 Hz. In use, the output is used to predict a service life of the rotatable component in response to the measured strain of the rotatable component.

In some cases, a frequency of a cyclic microstrain perturbation such as those of envelope 504 is determined to generally occur as a function of the type of pump, number of plungers of a pump, phasing of plungers of a pump, and/or type and number of pumps in parallel on a wellhead. Further, the cyclic microstrain perturbations such as those of envelope 504 is determined to generally occur as a function of the simultaneous operation of a group of pumps associated with a common manifold. In some cases, a fundamental frequency of the shaft 206 and/or associated drive line and/or transmission system depends on what gear the transmission is operated in and/or what gearing ratios exist in the pump gearbox 210. In some embodiments, information such as the information of output 500 is used to lengthen a service life of the shaft 206 and/or any other component of the pumping system 200. For example, knowledge of what forces, stresses, torques, and/or strains the shaft 206 experiences may be used to similarly calculate the forces, stresses, torques, and/or strains one or more components of the associated transmission and/or pump gearbox 210 experiences. In a manner similar to that described above, a service life of the components associated with the shaft 206 may be lengthened by calculating, monitoring, and/or otherwise managing operation of the pumping system 200 as a function of the information and data provided by the service life monitoring system 300. In some embodiments, the management of operation of the pumping system 200 and other parallel pumping systems in line, comprises operating the pumping system 200 to avoid and/or reduce overlap between (1) resonant/natural frequencies and/or harmonics of the resonant/natural frequencies of one or more components of the pumping system 200, (2) relative piston position between each pumping system 200 in line, and (3) the frequencies of potentially damaging stresses, strains, forces, torques, powers, and the like.

Examples of pumping parameters that may vary operation of a pump include, but are not limited to, changing a speed of operation of a pump, changing an upstream or downstream fluid pressure relative to a pump, changing a power consumption of a pump, and changing a torque and/or gearing associated with a pump. Further, the operation of a pump may be varied by changing a slip clutch setting (or similar device setting) of a pump, changing a composition of fluid fed to a pump (i.e., a viscosity or density of the fluid), and/or selectively operating a pump in on and off states. The operation of a pump may further be varied by changing other parameters of pump operation such as, but not limited to, changing an input and/or output fluid flowrate of a pump. Further, changing an electrical voltage supplied to a pump or changing a voltage and/or frequency waveform supplied to a pump (e.g., in a pump comprising a variable frequency drive motor) may vary the operation of a pump.

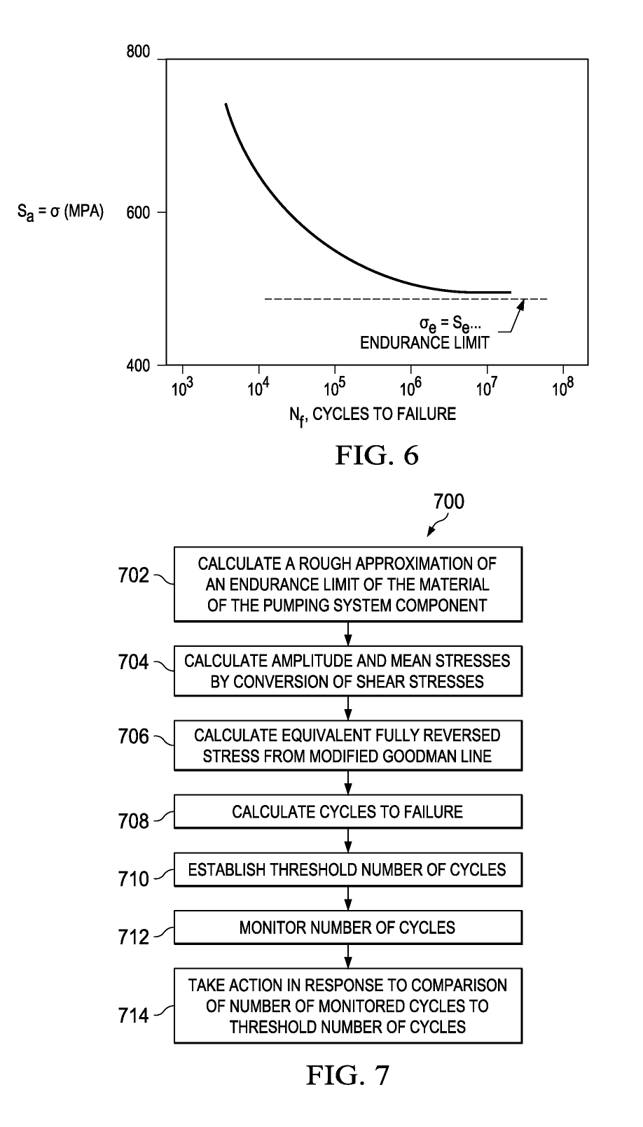

The shaft and transmission have a torsional resonance at relatively high-frequency, due to the large torsional stiffnesses of the components. In some embodiments, the torsional resonance frequency of the pumping system 200 may be about 32 Hz. This resonance tends to have very low-damping and as such, small excitations at this frequency can have a catastrophic impact over time. In embodiments where the pump 208 comprises a triplex pump operating at a normal speed, such as 2.6 Hz (resulting in a 8 Hz triplex output frequency), the third harmonic of this excitation lines up with the 32 Hz resonance (4×8=32 Hz) and over time, the relatively small input excitations will fatigue critical components of the pumping system 200. The systems and methods disclosed herein monitor the torsional strains and stresses experienced by one or more components of the pumping system 200 and if the stress levels get above a certain threshold level, a warning may be issued that the pump frequency or speed of the engine should change (possibly just very slightly) so that the harmonic excitation does not line up with the torsional resonance. Historical analysis of the stresses and/or strains yield a remaining fatigue life of the components through the acquisition of data from the rotatable measurement interface and use of classical fatigue life calculations to estimate remaining life as shown in FIG. 6.

In alternative embodiments, in addition and/or instead of monitoring fatigue of a component of the pumping system 200, the service life monitoring system 300 uses measured strain and estimated transmitted torque with information about a shaft rotational speed to estimate a transmitted power of the shaft that is powering the pump 208. In some embodiments, the transmitted power data is used by operators and/or the service life monitoring system 300 to evaluate how to operate their systems more efficiently, thereby potentially saving fuel and/or other energy costs of operating the pumping system 200.

It will be appreciated that the wellbore servicing systems and the methods disclosed herein can be used for any purpose. In an embodiment, the wellbore servicing systems and methods disclosed herein are used to service a wellbore that penetrates a subterranean formation by pumping a wellbore servicing fluid into the wellbore and/or subterranean formation. As used herein, a “servicing fluid” refers to a fluid used to drill, complete, work over, fracture, repair, or in any way prepare a well bore for the recovery of materials residing in a subterranean formation penetrated by the well bore. It is to be understood that “subterranean formation” encompasses both areas below exposed earth and areas below earth covered by water such as ocean or fresh water. Examples of servicing fluids include, but are not limited to, cement slurries, drilling fluids or muds, spacer fluids, fracturing fluids or completion fluids, and gravel pack fluids, all of which are well known in the art. Without limitation, servicing the well bore includes: positioning the wellbore servicing composition in the wellbore to isolate the subterranean formation from a portion of the wellbore; to support a conduit in the wellbore; to plug a void or crack in the conduit; to plug a void or crack in a cement sheath disposed in an annulus of the wellbore; to plug a perforation; to plug an opening between the cement sheath and the conduit; to prevent the loss of aqueous or nonaqueous drilling fluids into loss circulation zones such as a void, vugular zone, or fracture; to plug a well for abandonment purposes; to divert treatment fluids; and to seal an annulus between the wellbore and an expandable pipe or pipe string. In another embodiment, the wellbore servicing systems and methods are employed in well completion operations such as primary and secondary cementing operation to isolate the subterranean formation from a different portion of the wellbore.

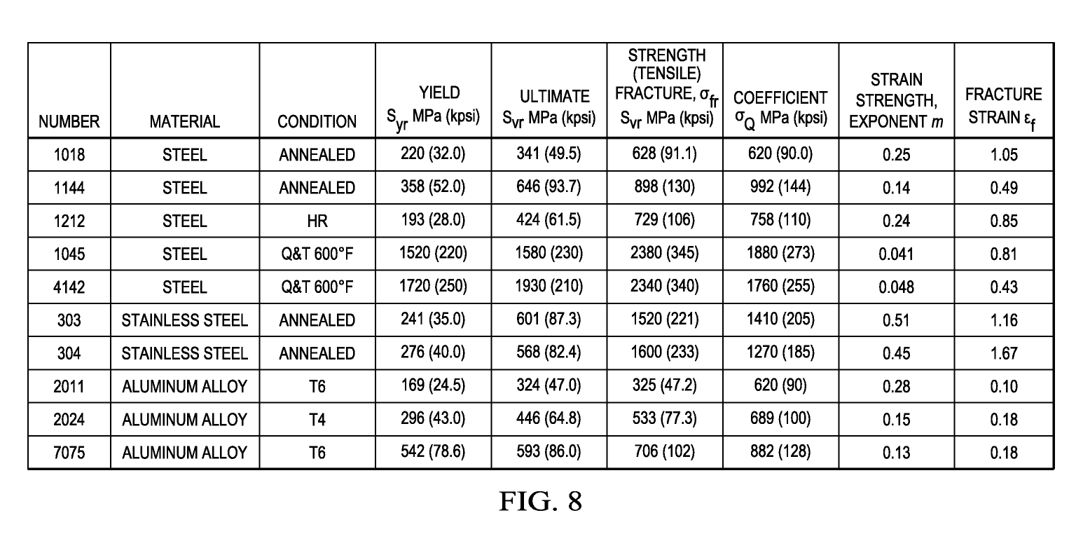

Referring now to FIG. 7, a flowchart of a method 700 of operating a service life monitoring system such as service life monitoring system 300 is shown. The method 700 begins at block 702 by calculating an approximation of an endurance limit of the material of a component of a pumping system such as a shaft 206. Calculating the approximation of the endurance limit of the material of the pumping system component comprises referencing a table of tensile test results, such as the chart of FIG. 8 for materials substantially similar to and/or for the material of the pumping system component to quickly obtain an ultimate strength, Sᵤₜ, of the material. The endurance limit of the material, Sₑ, of the material may be calculated according to Equation (1) below.

Sₑ=0.5Sᵤₜ Equation (1)

After calculating the endurance limit of the material, the method 700 continues at block 704 by calculating amplitude and mean stresses by conversion of shear stresses according to Equation (2) and Equation (3) below.

$$\begin{matrix}{σ}_{a} = \vert \frac{{σ}_{max} - {σ}_{min}}{2} \vert \sqrt{3} & Equation ( 2 ) \\ {σ}_{m} = \vert \frac{{σ}_{max} + {σ}_{min}}{2} \vert \sqrt{3} & Equation ( 3 )\end{matrix}$$

Next, the method 700 continues at block 706 by calculating an equivalent fully reversed stress utilizing the principles of a Modified Goodman Line and/or according to Equation (4) below.

$${σ}_{rev} = \frac{{σ}_{a}}{1 + \frac{{σ}_{m}}{{S}_{ut}}} \qquad Equation ( 4 )$$

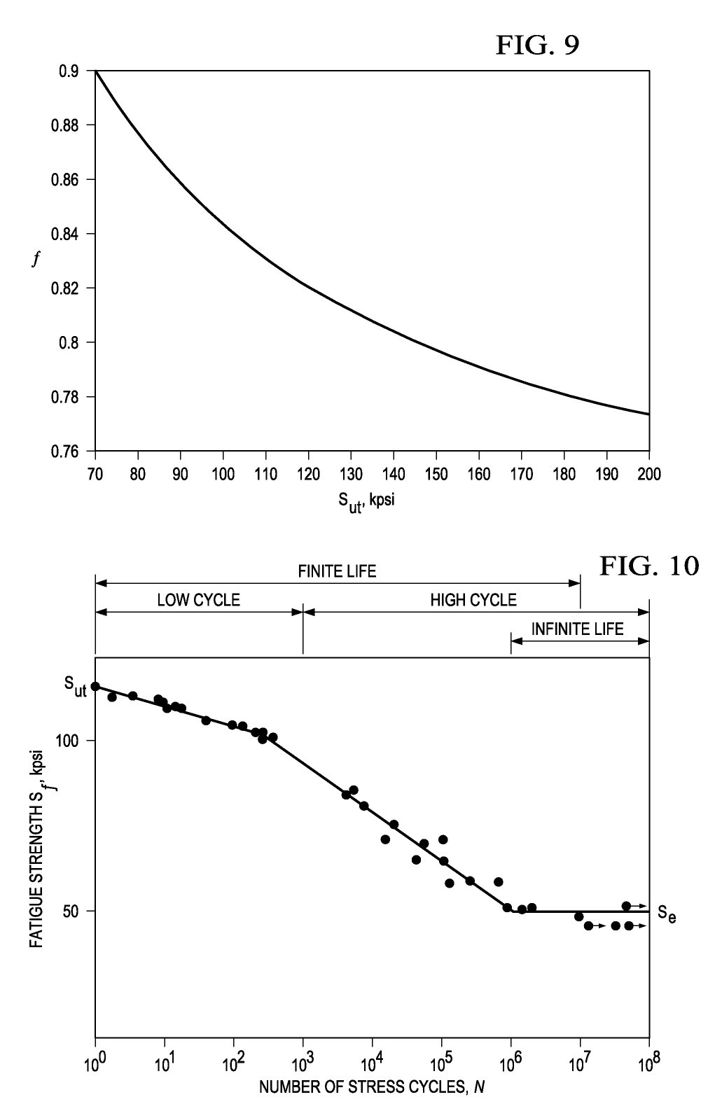

The method 700 continues at block 708 by calculating a number of cycles to failure according to Equation (5) below.

$$N = {( \frac{{σ}_{rev}}{a} )}^{\frac{1}{b}} where a = \frac{{( {fS}_{ut} )}^{2}}{{S}_{e}} , b = \frac{1}{3} {log}_{10} ( \frac{{fS}_{ut}}{{S}_{e}} ) \qquad Equation ( 5 )$$

Where a fatigue strength fraction, f, is obtained from a chart of ultimate strength of the material versus fatigue strength fraction, such as from the chart of FIG. 9.

The method 700 continues at block 710 by establishing a threshold number of cycles and/or equivalent cycles that may be used in a comparison against an actual and/or monitored number of cycles and/or equivalent cycles the pumping system component may endure during operation of the pumping system.

The method 700 continues at block 712 by monitoring the operation of the pumping system component and/or the pumping system as a whole to monitor and/or record the number of cycles and/or equivalent cycles the pumping system component has endured and/or may be projected to endure.

The method 700 continues at block 714 by comparing the previously established threshold number of cycles and/or equivalent cycles to the number of cycles and/or equivalent cycles the pumping system component has endured. In some embodiments, when the number of cycles and/or equivalent cycles meets and/or exceeds the established threshold number of cycles and/or equivalent cycles, the service life monitoring system may take an action. In some embodiments, the action taken comprise providing an alert to an operator of the pumping system 200, altering an operational speed, power, and/or any other control inputs of the pumping system 200, and/or any other suitable action that may impact extending a service life of the pumping system component and/or pumping system.

Referring now to FIG. 10, a chart of number of stress cycles versus fatigue strength is provided. The chart of FIG. 10 is a helpful resource in generalizing the affect variations in fatigue strength and number of stress cycles have on the potential longevity of a pumping system component.

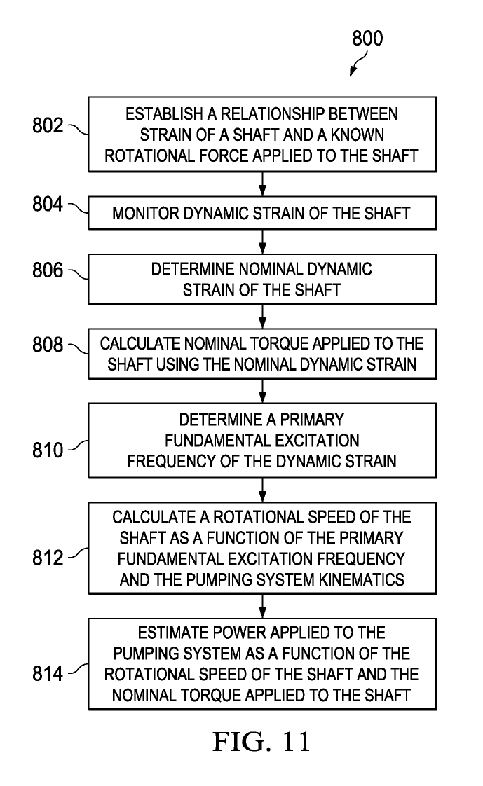

Referring now to FIG. 11, a flowchart of a method 800 of operating a service life monitoring system such as service life monitoring system 300 is shown. The method 800 begins at block 802 by determining a relationship between strain of a shaft such as shaft 206 and torque applied to the shaft. In some cases, measuring the strain of the shaft yields information necessary to determine a measurement of the torque applied to the shaft. In some embodiments, the relationship between strain of a shaft and the torque applied to a shaft is obtainable by statically rotationally loading the shaft with a known force or load and measuring a strain during the application of the known force or load. In some embodiments, the shaft surface strain can be analytically related to shaft torque via Equation (6) below:

$${ε}_{Torsional} = \frac{16 * {T}_{in * lbf} * {OD}_{Shaft} * ( 1 + v )}{π ( {OD}_{Shaft}^{4} - {ID}_{Shaft}^{4} ) * E} \qquad Equation ( 6 )$$

Where T is shaft torque in inch pounds, OD is shaft outer diameter in inches, u is poison's ratio, ID is inner diameter of the shaft in inches, and E is the shaft material modulus of elasticity in pounds per inch squared. In this embodiment, shaft strain can be measured after performing a shunt calibration and without a static rotational loading event.

The method 800 continues at block 804 by monitoring dynamic strain of the shaft. In some cases, the dynamic strain comprises a nominal strain value about which the dynamic strain generally repeatedly fluctuates with values alternatingly being greater than and less than the nominal strain value.

The method 800 continues at block 806 by determining a nominal strain value of the shaft.

The method 800 continues at block 808 by determining a nominal torque applied to the shaft as a function of the determined nominal strain value of the shaft and the relationship between strain and torque previously determined at block 802.

The method 800 continues at block 810 by determining a primary fundamental excitation frequency of the dynamic strain from the dynamic strain of the shaft monitored at block 804.

The method 800 may continue at block 812 by calculating a rotational speed of the shaft as a function of the primary fundamental excitation frequency and the pumping system kinematics. In some embodiments, the pumping system kinematics comprise parameters such as, but not limited to, a number of plungers and/or pistons, a number of phases of sets of plungers and/or pistons, and/or a gearing ratio of a pump gearbox such as pump gearbox 210.

The method 800 may continue at block 812 by alternately calculating a shaft rotational speed based on electrical pulses in the inductive coil system as the coils pass each other rotationally during normal pump system 200 operation. This pulse signature, being consistent between different operational conditions and shaft sizes, may be used to derive and report shaft RPM. Following RPM derivation, and using measured strain to derive shaft torque, shaft transmitted power may be derived by using Equation (7) below:

$$P \text{/} hp = \frac{τ \text{/} in \cdot lbf \times f \text{/} rpm}{\text{63,025}} \qquad Equation ( 7 )$$

The method 800 may continue at block 814 by calculating an estimated power applied to the pumping system as a function of the rotational speed of the shaft calculated at block 812 and the nominal torque applied to the shaft calculated at block 808.

In some embodiments, the method 800 may continue by taking an action in response to the estimated power calculated at block 814. In some embodiments, the action taken comprises providing an alert to an operator of a pumping system, altering an operational speed and/or power of a pumping system, and/or any other suitable action that impacts extending a service life of a pumping system component and/or otherwise managing operation of a pumping system.

In some embodiments, the wireless monitoring system is powered by batteries that rotate with the entire assembly in such a manner that is consistent with a statically or dynamically balanced rotating assembly.

In some embodiments, the wireless monitoring system is powered by an inductive coil assembly in such a way as to have a coil rotating with the entire assembly in such a manner that is consistent with a statically or dynamically balanced rotating assembly. A second coil and inductive powering assembly is also installed in the fixed frame of reference in such a way as to allow the rotating coil to pass in close proximity during its rotation thereby powering the wireless measurement electronics via inductive effect.

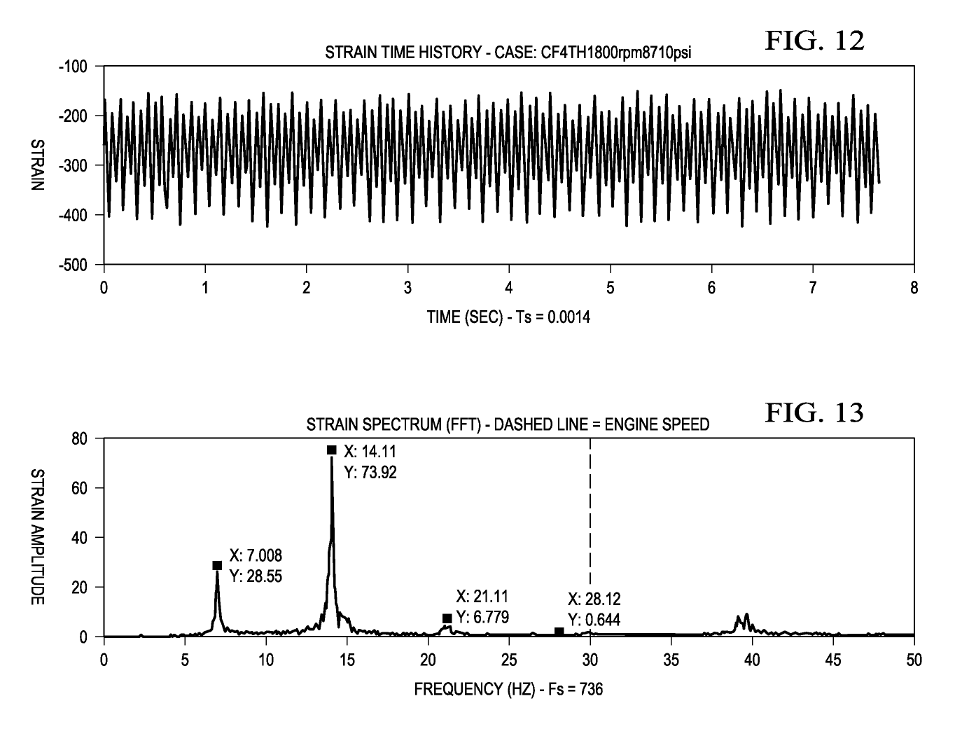

In a first example case of implementing the method 800, block 802 determines that torque (T)=40(in lbs)*(microstrain). Next, implementation of block 804 yields the strain time history graph of FIG. 12 and the strain spectrum graph of FIG. 13. Next, implementation of block 806 yields determination of a nominal strain of −300 microstrain with about a +/−100 microstrain dynamic input. Next, with T=40(in lbs)*(microstrain), implementation of block 808 yields a nominal torque of 12,000 in lbs. Next, implementation of block 810 and related inspection of the strain spectrum graph of FIG. 13 yields a primary fundamental excitation frequency of about 7.01 Hz. Next, implementation of block 812 uses knowledge regarding gearing ratios of shaft rotation to pump speed. For example, with the knowledge that a pump is a triplex pump with three plungers, a relationship between the shaft speed and the pump speed is determined by the gear box between the two, and where the gearing has that the piston rotational speed is 6.9 times lower than the shaft speed, 7.01 Hz input generated by 3 pistons, the rotational speed of the shaft can be calculated to be 967 RPM (i.e. 7.01 cycles/sec*(1/3)*6.9*60 sec/min). In some cases, such a calculation may be made without the use of a tachometer. Next, implementation of block 814 determines an estimated power applied to the pumping system and the estimated power may be obtained and/or calculated utilizing Equation (8) below.

P=Tω Equation (8)

Where T is the torque applied to the drive shaft and ω is the rotation speed of the shaft. Equation (9) below is used to calculate a horsepower of 184 hp.

$$P \text{/} hp = \frac{τ \text{/} in \cdot lbf \times f \text{/} rpm}{\text{63,025}} \qquad Equation ( 9 )$$

In the manner described above, power supplied to the pumping system is estimated without the need to utilize information regarding fuel burn rates, nominal size of the engine (subtracting the estimated frictional losses), engine dynamometers, and the like, but rather, by using information gathered by a service life monitoring system such as service life monitoring system 300.

In the manner described above, analysis such as torque, shaft horsepower, pump efficiency, shaft resonance, remaining service life, and other such derivations are accomplished in a cloud based analytics platform, such as SensorCloud, to evaluate and process data semi-real time.

In some embodiments, system limits established by the user, such as maximum torque, maximum load, maximum stress, maximum dynamic torque, or other such variables, will be used in confluence with a cloud based analytics platform, such as SensorCloud, to provide user notifications or warnings in semi-real time, that allow the customer to change the current operating condition of the equipment in such a manner as to avoid system damage.

In some embodiments, the wireless network aggregator, such as a LORD Sensing Systems WSDA-1000 or WSDA-RGD, pulls hydraulic fracturing truck system data from a controller, and upload that information to a cloud network, such as SensorCloud, for use in analysis of system health and monitoring, deriving metrics such as those previously mentioned, condition based maintenance, or preventative maintenance.

In some embodiments, the wireless network aggregator, such as a LORD Sensing Systems WSDA-1000 or WSDA-RGD, pushes wirelessly collected data, such as torque, strain, load, or other similarly derived metrics, to the hydraulic fracturing truck system controller for use in feedback control with devices such as the torsional dampener or, pulsation dampener, or other equivalent dynamic hydraulic fracturing systems that improve operational and/or system lifetime characteristics.

In a method of servicing a wellbore, the method comprises providing a rotatable component. The method includes disposing a rotatable measurement interface on the rotatable component. The method includes rotating the rotatable component. And the method includes operating the rotatable measurement interface to measure a service life parameter of the rotatable component. The method further comprises recording the service life parameter to a memory of the rotatable measurement interface 302,400. The method also further comprises wirelessly transmitting the service life parameter. The method of wirelessly transmitting the service life parameter further comprises receiving the wirelessly transmitted service life parameter to a data receiver 304 that is located remote from the rotatable component. The method of wirelessly transmitting the service life parameter, wherein the service life parameter further comprises a rotational parameter of the rotatable component. The method with the rotatable component further comprises the rotatable component having a shaft 206 configured to drive a pump 208. The method related to the service life parameter further selecting the service life parameter from the group consisting of a strain, a stress, a torque, a power and combinations thereof. The method further comprising changing a rate of rotation of the rotatable component in response to the measured service life parameter.

In a method of servicing a wellbore, the method comprises providing a rotatable component. The method includes disposing a rotatable measurement interface on the rotatable component. The method provides for rotating the rotatable component and operating the rotatable measurement interface to measure a strain of the rotatable component. The method also provides for predicting a service life of the rotatable component in response to the measured strain of the rotatable component. The rotatable component comprises a shaft 206 configured to drive a pump 208. The method further comprises locating a torsional strain gauge 404 of the rotatable measurement interface 302,400 radially between the rotatable component and a sleeve enclosure 308 of the rotatable measurement interface 302,400. The method further comprises locating a torsional strain gauge 404 on the rotatable component remotely with respect to a sleeve enclosure 308 of the rotatable measurement interface 302,400. The method further comprises wirelessly communicating the measured strain to a wireless data transmission component. The method further comprises transmitting the measured strain of the rotatable component from the wireless data transmission component to a service life management computer. The method further comprises determining at least one of a power, a rotational speed, and a torque of the rotatable component. The method further comprises providing an alert when the at least one of the determined power, the rotational speed, the torque, and the service life of the rotatable component exceeds a predetermined threshold. The method further comprises changing at least one of the power, the rotational speed, and the torque of the rotatable component.

Other embodiments of the current invention will be apparent to those skilled in the art from a consideration of this specification or practice of the invention disclosed herein. Thus, the foregoing specification is considered merely exemplary of the current invention with the true scope thereof being defined by the following claims.

What is claimed is:

1. A method of servicing a wellbore, comprising:
providing a rotatable component;
disposing a rotatable measurement interface on the rotatable component;
rotating the rotatable component; and
operating the rotatable measurement interface to measure a service life parameter of the rotatable component.

2. The method of claim 1, further comprising recording the service life parameter to a memory of the rotatable measurement interface.

3. The method of claim 1, further comprising wirelessly transmitting the service life parameter.

4. The method of claim 3, further comprising receiving the wirelessly transmitted service life parameter to a data receiver that located remote from the rotatable component.

5. The method of claim 3, wherein the rotatable component comprises a shaft configured to drive a pump.

6. The method of claim 3, wherein the service life parameter is selected from the group consisting of a strain, a stress, a torque, a power and combinations thereof.

7. The method of claim 1, further comprising changing a rate of rotation of the rotatable component in response to the measured service life parameter.

8. A method of servicing a wellbore, comprising:
providing a rotatable component;
disposing a rotatable measurement interface on the rotatable component;
rotating the rotatable component;
operating the rotatable measurement interface to measure a strain of the rotatable component; and
predicting a service life of the rotatable component in response to the measured strain of the rotatable component.

9. The method of claim 8, wherein the rotatable component comprises a shaft configured to drive a pump.

10. The method of claim 8, further comprising locating a torsional strain gauge of the rotatable measurement interface radially between the rotatable component and a sleeve enclosure of the rotatable measurement interface.

11. The method of claim 8, further comprising locating a torsional strain gauge on the rotatable component remotely with respect to a sleeve enclosure of the rotatable measurement interface.

12. The method of claim 8, further comprising wirelessly communicating the measured strain to a wireless data transmission component.

13. The method of claim 12, further comprising transmitting the measured strain of the rotatable component from the wireless data transmission component to a service life management computer.

14. The method of claim 8, further comprising determining at least one of a power, a rotational speed, and a torque of the rotatable component.

15. The method of claim 14, further comprising providing an alert when the at least one of the determined power, the rotational speed, the torque, and the service life of the rotatable component exceeds a predetermined threshold.

16. The method of claim 14, further comprising changing at least one of the power, the rotational speed, and the torque of the rotatable component.

17. A service life monitoring system, comprising:
a rotatable component; and
a rotatable measurement interface disposed on the rotatable component, the rotatable measurement interface includes:
a strain gauge configured to measure a strain of the rotatable component; and
a strain monitor controller configured to receive the strain of the rotatable component.

18. The system of claim 17, wherein the rotatable component comprises a shaft.

19. The system of claim 17, wherein the measuring component is located radially between the rotatable component and a sleeve enclosure of the rotatable measurement interface.

20. The system of claim 17, wherein the measuring component is located on the rotatable component remotely with respect to a sleeve enclosure of the rotatable measurement interface.

21. The system of claim 17, further comprising:
at least one power source configured to provide electrical power to at least one component of the rotatable measurement interface.

22. The system of claim 21, wherein the at least one power source comprises at least one battery.

23. The system of claim 21, wherein the at least one power source comprises two inductive coils arranged in proximity to transfer power from a fixed component to the rotatable component.

24. The system of claim 17, wherein the strain motor controller is located internally to a sleeve enclosure of the rotatable measurement interface.

25. The system of claim 17, wherein the strain monitor controller is configured to wirelessly communicate the measured strain to a wireless data transmission component.

26. The system of claim 25, wherein the wireless data transmission component is configured to transmit the measured strain of the rotatable component to a service life management computer.

27. The system of claim 26, wherein the service life management computer is configured to associate a torque with the rotatable component in response to receiving the measured strain of the rotatable component.

28. The system of claim 27, wherein the service life management computer is configured to provide an alert when the torque of the rotatable component exceeds a predetermined threshold.

29. The system of claim 27, wherein the service life management computer is configured to control at least one of the power, the rotational speed, and the torque of the rotatable component.

30. The system of claim 29, wherein the service life management computer is configured to predict a service life of the rotatable component in response to determining the torque associated with the rotatable component.

31. The system of claim 17, wherein the service life monitoring system is a component of a pumping system.

32. The system of claim 31, wherein the pumping system is disposed on a hydraulic fracturing truck.

33. The system of claim 31, wherein the pumping system is used to service a well and incorporates at least a pump, a shaft and a prime mover.

34. A service life monitoring system, comprising:
a rotatable component; and
a rotatable measurement interface disposed on the rotatable component, the rotatable measurement interface comprising:
a strain gauge configured to measure a strain of the rotatable component;
a strain monitor controller configured to receive the measured strain of the rotatable component; and
a wireless data transmission component configured to wirelessly communicate with the strain monitor controller to determine an operating parameter of the rotatable component.

35. The system of claim 34, wherein the rotatable component comprises a shaft strain gauge

36. The system of claim 34, wherein the strain gauge is located radially between the rotatable component and a sleeve enclosure of the rotatable measurement interface.

37. The system of claim 34, wherein the strain gauge is located on the rotatable component remotely with respect to a sleeve enclosure of the rotatable measurement interface.

38. The system of claim 34, further comprising:
at least one power source configured to provide electrical power to at least one component of the rotatable measurement interface.

39. The system of claim 38, wherein the at least one power source comprises at least one battery.

40. The system of claim 38, wherein the at least one power source comprises two inductive coils arranged in proximity to transfer power from a fixed component to the rotatable component.

41. The system of claim 34, wherein the strain motor controller is located internally to a sleeve enclosure of the rotatable measurement interface.

42. The system of claim 34, wherein the strain monitor controller is configured to wirelessly communicate the measured strain to a wireless data transmission component.

43. The system of claim 42, wherein the wireless data transmission component is configured to transmit the measured strain of the rotatable component to a service life management computer.

44. The system of claim 43, wherein the service life management computer is configured to determine at least one of a power, rotational speed, torque, and service life of the rotatable component in response to receiving the measured strain of the rotatable component.

45. The system of claim 44, wherein the service life management computer is configured to provide an alert when the at least one of the determined power, rotational speed, torque, and service life of the rotatable component exceeds a predetermined threshold.

46. The system of claim 44, wherein the service life management computer is configured to control at least one of the power, the rotational speed, and the torque of the rotatable component.

47. The system of claim 44, wherein the service life management computer is configured to predict a service life of the rotatable component in response to determining the torque associated with the rotatable component.

48. The system of claim 34, wherein the service life monitoring system is a component of a pumping system.

49. The system of claim 48, wherein the pumping system is disposed on a hydraulic fracturing truck.

50. The system of claim 48, wherein the pumping system is used to service a well and incorporates at least a pump, a shaft and a prime mover.

51. A service life monitoring system, comprising:
a rotatable component; and
a rotatable measurement interface disposed on the rotatable component, the rotatable measurement interface comprising:
at least one torsional strain gauge configured to measure a strain of the rotatable component;
a strain monitor controller configured to receive the measured strain of the rotatable component; and
a wireless data transmission component configured to wirelessly communicate with the strain monitor controller to determine a service life of the rotatable component as a result of the measured strain of the rotatable component.

51. The system of claim 50, wherein the rotatable component comprises a shaft.

52. The system of claim 50, wherein the at least one torsional strain gauge is located radially between the rotatable component and a sleeve enclosure of the rotatable measurement interface.

53. The system of claim 50, wherein the at least one torsional strain gauge is located on the rotatable component remotely with respect to a sleeve enclosure of the rotatable measurement interface.

54. The system of claim 50 wherein the strain monitor controller is configured to wirelessly communicate the measured strain to the wireless data transmission component.

55. The system of claim 54, wherein the wireless data transmission component is configured to transmit the measured strain of the rotatable component to a service life management computer.

56. The system of claim 55, wherein the service life management computer is configured to determine at least one of a power, rotational speed, torque, and service life of the rotatable component in response to receiving the measured strain of the rotatable component.

57. The system of claim 56, wherein the service life management computer is configured to provide an alert when the at least one of the determined power, rotational speed, torque, and service life of the rotatable component exceeds a predetermined threshold.

58. The system of claim 56, wherein the service life management computer is configure to control at least one of the power, the rotational speed, and the torque of the rotatable component.

59. The system of claim 56, wherein the service life management computer is configured to predict a service life of the rotatable component in response to determining the torque associated with the rotatable component.

60. The system of claim 50, wherein the service life monitoring system is a component of a pumping system.

61. The system of claim 60, wherein the pumping system is disposed on a hydraulic fracturing truck.

62. The system of claim 60, wherein the pumping system is used to service a well and incorporates at least a pump, a shaft and a prime mover.
